(19) United States
(12) Patent Application Publication
(10) Pub. No.: US 2017/0073490 A1
(43) Pub. Date: Mar. 16, 2017

(54) FOAMED THERMOPLASTIC POLYURETHANE AND MICROWAVE MOLDED ARTICLE THEREOF

(71) Applicants: Sunko Ink Co., Ltd., Taichung City (TW); Tayin Research & Development Co., Ltd., Taichung City (TW)

(72) Inventors: Yi-Jung Huang, Taichung City (TW); Ching Hui Lin, Taichung City (TW); Ting-Kai Huang, Taichung City (TW); Hsin-Hung Lin, Taichung City (TW); Chien-Yuan Chiu, Taichung City (TW); Hong-Yi Lin, Taichung City (TW); Kuo-Fen Shih, Taichung City (TW); Ya-Chi Wang, Taichung City (TW)

(21) Appl. No.: 15/261,574

(22) Filed: Sep. 9, 2016

(30) Foreign Application Priority Data
Sep. 11, 2015 (TW) 104130207
Sep. 11, 2015 (TW) 104130208
Dec. 17, 2015 (TW) 104142454

(51) Int. Cl. C08J 9/228; C08J 9/32; C08J 9/00; B29C 45/00; C08J 9/12; C08J 9/14; C08G 18/00; C08J 9/20; C08J 9/36

(52) U.S. Cl. CPC C08J 9/228; C08J 9/20; C08J 9/32; C08J 9/0066; C08J 9/0023; C08J 9/0095; C08J 9/36; C08J 9/122; C08J 9/141; C08G 18/00; B29C 45/0001; C08J 2203/06; C08J 2203/14; C08J 2203/22; C08J 2375/04; C08G 2101/005

(57) ABSTRACT

A foamable composition for preparing foamed thermoplastic polyurethane, and microwave molded articles thereof are provided. The foamable composition comprises non-foamed thermoplastic polyurethane particles and a foaming agent, wherein the non-foamed thermoplastic polyurethane particles have a viscosity between 10,000 poise and 40,000 poise measured at 170° C. according to JISK 7311 test method.

### CROSS REFERENCE OF RELATED APPLICATIONS

This application claims the benefit of priority of TW Patent Applications No. 104130207 and No. 104130208 filed on Sep. 11, 2015, and TW Patent Application No.104142454 filed on Dec. 17, 2015, the contents of which is incorporated herein by reference in their entirety.

### BACKGROUND OF THE INVENTION

Field of the Invention

The invention relates to foamed thermoplastic polyurethane and microwave molded articles thereof.

Description of the Prior Art

Thermoplastic polyurethane (TPU) is the raw material of thermoplastic elastomers (TPE). The TPE made from TPU has many advantages, such as viscosity, high elasticity, abrasion resistance, impact resistance, distortion resistance, high extensibility, weather resistance, chemical resistance, non-toxicity, and high tear strength etc., and has been widely used in shoes, automobiles, packaging materials, heat insulation materials, and other products.

Injection molding is the most common method for preparing TPU molded foam in the prior art. The injection molding process involves heating the plastic rubber particles in the injection molding machine to form a melt, which is then compressed to move through the nozzles and injected into the mold at lower temperature. Therefore, the production process of injection molding is time consuming. Also, the weight of the injection mold is quite heavy, leading to the inconvenience of replacement of the mold. Another method for preparing TPU molded foam in the prior art is steam molding method. However, the steam molding method involves high-temperature or high-pressure processes, which often need to consume more energy, resulting in increased costs and thus lowering economic efficiency and commercial value for the TPU molded foam product. In addition, to enhance the utility of TPU molded foam used in all kinds of products, for example, the improvements of the physical properties of TPU molded foam, is also a subject of research in the industry. For instance, there exists a need to reduce the density of the TPU molded foam for manufacturing shoes with comfort, flexibility and light weight.

### SUMMARY OF THE INVENTION

In view of the above, the present invention in one aspect provides a foamable composition (also called formulation) for the preparation of foamed thermoplastic polyurethanes, foamed thermoplastic polyurethanes prepared through the foaming and pelletizing of the composition described above and a method of foaming and pelletizing thereof. The foamed thermoplastic polyurethanes of the present invention have a microwave-refoamable property, so the present invention further provides a microwave molded article prepared through second foaming of the foamed thermoplastic polyurethanes described above and a method for manufacturing the same. The foamed thermoplastic polyurethanes of the present invention have an advantage of light weight. After the treatment of the foamable composition with microwave, the thermoplastic polyurethane will have a bonding effect on the surfaces of its particles and will be re-foamed simultaneously so as to form the microwave molded article (or called thermoplastic polyurethane foam). Unlike conventional injection molding method and steam molding method, the microwave method for preparing molded articles is simple in process as well as time- and energy-saving.

In one embodiment, the present invention provides a foamable composition for preparing foamed thermoplastic polyurethane, comprising non-foamed thermoplastic polyurethane particles and a foaming agent, wherein the non-foamed thermoplastic polyurethane particles have a viscosity between 10,000 poise and 40,000 poise measured at 170° C. according to JISK 7311 test method.

In another embodiment, the present invention provides the foamable composition as above, wherein the viscosity of the non-foamed thermoplastic polyurethane particles is between 15,000 poise and 35,000 poise.

In another embodiment, the present invention provides the foamable composition as above, wherein the non-foamed thermoplastic polyurethane particles have a particle size between 2.5 mm and 4.5 mm.

In another embodiment, the present invention provides the foamable composition as above, wherein the non-foamed thermoplastic polyurethane particles have a hardness of 40 Shore A scale to 64 Shore D scale.

In another embodiment, the present invention provides the foamable composition as above, wherein the non-foamed thermoplastic polyurethane particles have a density between 1.0 g/cm³ and 1.25 g/cm³.

In another embodiment, the present invention provides the foamable composition as above, comprising 100 parts by weight of the non-foamed thermoplastic polyurethane particles and 5 to 25 parts by weight of the foaming agent.

In another embodiment, the present invention provides the foamable composition as above, comprising 100 parts by weight of the non-foamed thermoplastic polyurethane particles and 5 to 20 parts by weight of the foaming agent.

In another embodiment, the present invention provides the foamable composition as above, wherein the foaming agent is composed of expandable microspheres, carbon dioxide (CO2) or hydrocarbons having 4 to 10 carbon atoms.

In another embodiment, the present invention provides the foamable composition as above; further comprising 0.1 to 5 parts by weight of talc powder.

In another embodiment, the present invention provides the foamable composition as above, further comprising 1 to 20 parts by weight of a plasticizer, wherein the plasticizer is benzoate or a derivative thereof.

In another embodiment, the present invention provides the foamable composition as above, further comprising 0.1 to 5 parts by weight of pigment powders, based on 100 parts by weight of the non-foamed thermoplastic polyurethane particles.

In another embodiment, the present invention provides a foamed thermoplastic polyurethane, prepared through the foaming and pelletizing of the foamable composition as above.

In another embodiment, the present invention provides the foamed thermoplastic polyurethane as above, wherein the foamed thermoplastic polyurethane contains residual foaming agent.

In another embodiment, the present invention provides the foamed thermoplastic polyurethane as above, wherein the foamed thermoplastic polyurethane has a particle size between 3 mm and 7.5 mm.

In another embodiment, the present invention provides the foamed thermoplastic polyurethane as above, wherein the foamed thermoplastic polyurethane has a hardness of 40 Shore C scale to 80 Shore C scale.

In another embodiment, the present invention provides the foamed thermoplastic polyurethane as above, wherein the foamed thermoplastic polyurethane has a density between 0.2 g/cm³ and 0.8 g/cm³.

In another embodiment, the present invention provides the foamed thermoplastic polyurethane as above, wherein a single particle of the foamed thermoplastic polyurethane has a plurality of colors.

In another embodiment, the present invention provides a microwave molded article, prepared from the foamed thermoplastic polyurethane as above being treated by microwave.

In another embodiment, the present invention provides the microwave molded article as above, wherein the microwave molded article has a density between 0.15 g/cm³ and 0.6 g/cm³.

In another embodiment, the present invention provides the microwave molded article as above, wherein the microwave molded article has a hardness of 40 Shore C scale to 80 Shore C scale.

In another embodiment, the present invention provides the microwave molded article as above, wherein a surface of the microwave molded article has a designed pattern.

In another embodiment, the present invention provides a method for manufacturing the microwave molded article as above, wherein a power of microwave is between 500 W and 30,000 W at frequency for microwave 2,450 MHz.

In another embodiment, the present invention provides the method for manufacturing the microwave molded article as above, wherein the duration of microwave is between 3 seconds and 300 seconds.

In another embodiment, the present invention provides the method for manufacturing the microwave molded article as above, wherein no water is added during the treatment of microwave.

In another embodiment, the present invention provides the method for manufacturing the microwave molded article as above, wherein 1 to 10 parts by weight of water or alcohol is added during the treatment of microwave, based on 100 parts by weight of the foamed thermoplastic polyurethane.

In another embodiment, the present invention provides the method for manufacturing the microwave molded article as above, further comprising using a container to contain the foamed thermoplastic polyurethane for carrying out the treatment of microwave, wherein the container is a composite of metal and a plastic.

In another aspect, the present invention provides foamed thermoplastic polyurethanes. The foamed thermoplastic polyurethanes can be obtained by foaming and pelletizing of any suitable composition. The foamed thermoplastic polyurethanes of the present invention have a microwave-refoamable property, so the present invention further provides a microwave molded article prepared through second foaming of the foamed thermoplastic polyurethanes described above and a method for manufacturing the same.

In one embodiment, the present invention provides a foamed thermoplastic polyurethane, wherein the foamed thermoplastic polyurethane has at least one of properties as below: a particle size between 3 mm and 7.5 mm; a hardness of 40 Shore C scale to 80 Shore C scale; and a density between 0.2 g/cm³ and 0.8 g/cm³.

In another embodiment, the present invention provides the foamed thermoplastic polyurethane as above wherein the foamed thermoplastic polyurethane contains residual foaming agent.

In another embodiment, the present invention provides the foamed thermoplastic polyurethane as above, wherein a single particle of the foamed thermoplastic polyurethane has a plurality of colors.

In still another aspect, the present invention provides a microwave molded article which can be made from any suitable foamed thermoplastic polyurethane.

In one embodiment, the present invention provides a microwave molded article having at least one of the below properties: a density between 0.15 g/cm³ and 0.6 g/cm³, and a hardness of 40 Shore C scale to 80 Shore C scale.

In another embodiment, the present invention provides the microwave molded article as above, wherein a surface of the microwave molded article has a designed pattern.

In another embodiment, the present invention provides a method for manufacturing the microwave molded article as above, wherein a power of microwave is between 500 W and 30,000 W at frequency for microwave 2,450 MHz.

In another embodiment, the present invention provides the method for manufacturing the microwave molded article as above, wherein the duration of microwave is between 3 seconds and 300 seconds.

Other aspects and a variety of microwave molded articles are included in the present invention for resolving other problems, and will be disclosed in detail in conjunction with the aspects described above in the following detailed description.

### BRIEF DESCRIPTION OF THE DRAWINGS

FIGS. 1a and 1b show the microwave molded article according to one embodiment of the present invention;

FIGS. 2a and 2b show the failed microwave molded article;

FIG. 3 shows another failed microwave molded article;

FIG. 4 shows the scanning electron microscope image of the molded article according to one embodiment of the present invention;

FIG. 5 shows the scanning electron microscope image of a failed molded article; and

FIGS. 6 and 7 show the microwave molded article having a surface with a designed pattern according to one embodiment of the present invention.

### DETAILED DESCRIPTION OF THE EMBODIMENTS

For fully understanding the present invention and the claims asserted therein, preferred embodiments of the invention will be demonstrated below. The descriptions about well-known components, related materials, and associated processing techniques will be omitted to avoid obscuring the content of the invention.

Preparation of the Foamable Compositions for Foamed Thermoplastic Polyurethanes

The foamable compositions for preparing foamed thermoplastic polyurethanes of the present invention mainly comprise non-foamed thermoplastic polyurethane particles and a foaming agent. The viscosity of the non-foamed thermoplastic polyurethane particles of the composition is between 10,000 poise and 40,000 poise, which facilitates preliminary foamed particles to proceed with a second foaming well. The viscosity is measured at 170° C. according to JISK 7311 test method. Preferably, the viscosity of the non-foamed thermoplastic polyurethane particles is between 15,000 poise and 35,000 poise, which enhanced both the second foaming ability of the preliminary foamed particles and the mechanical strength of the re-foamed materials. The content of the foaming agent is preferably 5 to 25 parts by weight, based on 100 parts by weight of the non-foamed thermoplastic polyurethane particles, and more preferably 5 to 20 parts by weight if better mechanical strength is needed. According to the embodiments of the present invention, the non-foamed thermoplastic polyurethane particles of the composition preferably have a particle size between 2.5 mm (millimeter) and 4.5 mm. As described herein, particle size is referred to the measurements of the longest axes of the particles. According to other embodiments of the present invention, the non-foamed thermoplastic polyurethane particles of the composition preferably have a hardness of 40 Shore A scale to 64 Shore D scale. According to still other embodiments of the present invention, the non-foamed thermoplastic polyurethane particles of the composition preferably have a density between 1.0 g/cm³ and 1.25 g/cm³. The density as referred to herein is measured according to the Archimedes principle (buoyancy method).

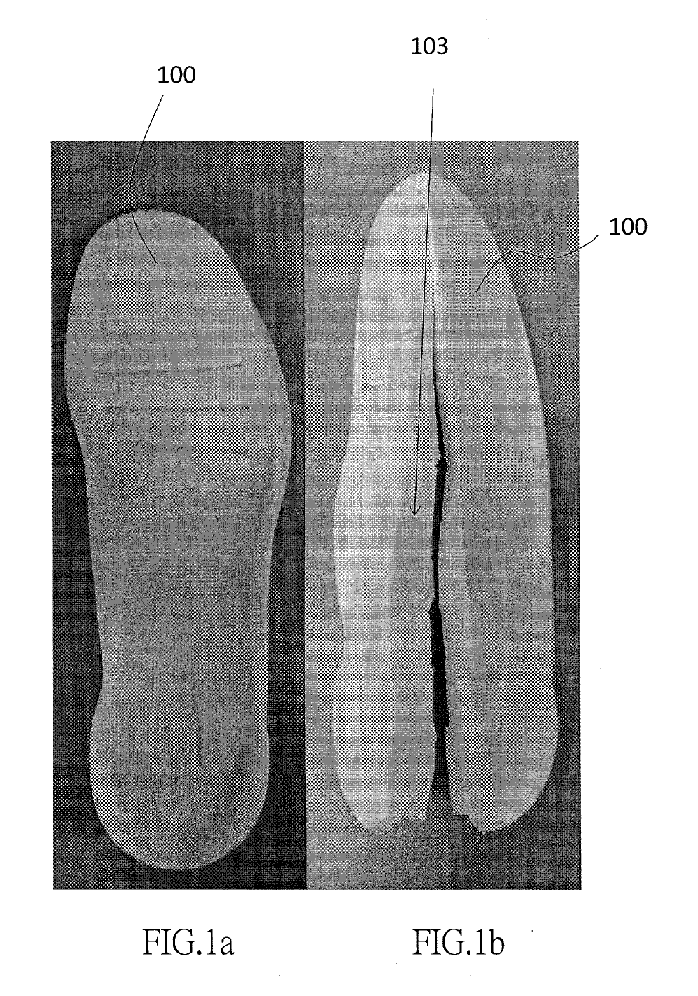

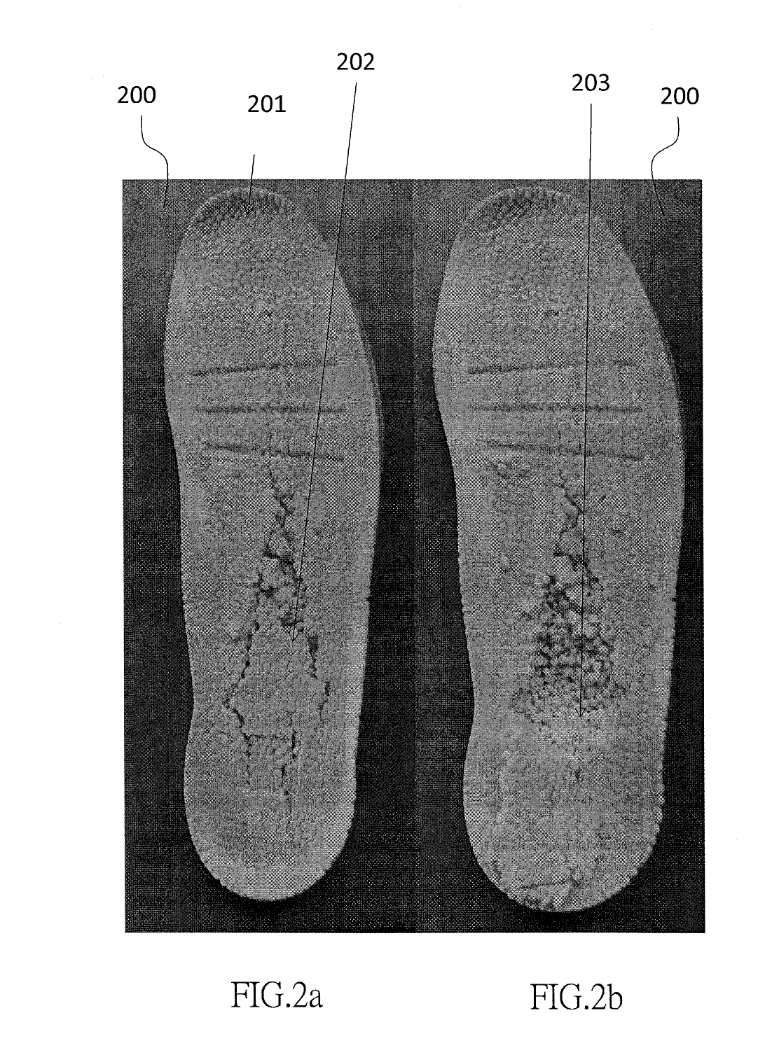

The foamed thermoplastic polyurethanes of the present invention have a good re-foaming property. The so-called “re-foaming” property means that the foamed thermoplastic polyurethane formed through the preliminary foaming can be foamed again (for the second time), especially by the treatment of microwave. After the re-foaming, the particles of such kind of foamed thermoplastic polyurethane expand significantly and bond closely to form a foamed, molded article exhibiting a full shape, which represents a good re-foaming. On the contrary, for the foamed thermoplastic polyurethanes prepared from the non-foamed thermoplastic polyurethane particles having a viscosity outside the range as described above, they fail to expand significantly after the treatment of microwave. In addition, they formed a collapsed structure due to the lack of bonding between most of the particles, and failed to form the microwave molded article with a full shape appearance. This represents a bad re-foaming. For example, FIGS. 1a-1b show the microwave molded article 100 prepared from the non-foamed thermoplastic polyurethane particles having a viscosity in the range described above (well re-foamed); and FIGS. 2a-2b show the failed, microwave molded article 200 prepared from non-foamed thermoplastic polyurethane particles having a viscosity outside the range (badly re-foamed). FIG. 1a shows the overall appearance of the microwave molded article 100 having a full shape, and FIG. 1b shows the internal structure of the microwave molded article 100 being cut by external force intentionally. FIG. 2a shows the overall appearance of the microwave molded article 200, and FIG. 2b shows the internal structure of the microwave molded article 200 torn by external force intentionally. By comparison, it can be observed that FIGS. 2a and 2b show totally different results, such as the subsidence region 201 and the inter-particle non-bonding region 202 of the microwave molded article 200. FIG. 1b shows the continuous distribution phase 103, where the particles in the internal structure bond closely and have no clear boundaries. By contrast, FIG. 2b shows the non-continuous distribution phase 203 resulted from the loose particles in the internal structure. In FIG. 2b, the particles in some regions visually seemed bonding with each other, but peeled loosely upon a slight stir, wherein each particle keeps its own complete shape and the particles internally have clear boundaries from each other.

The non-foamed thermoplastic polyurethane particles of the foamable composition can be esters, ethers, polycaprolactones, or polycarbonates. As to the preparation of the non-foamed thermoplastic polyurethane particles, for example, diisocyanate, polyester polyol, the chain extender, the catalysts and other additives can be mixed to react at about 200-300° C. and then subjected to the injection molding or extrusion treatment known in the art to obtain non-foamed thermoplastic polyurethane particles. Diisocyanate can be selected from 4,4-methylene bis(phenyl isocyanate) (MDI), m-xylylene diisocyanate (XDI), 1,4-phenylene diisocyanate, 1,5-naphthalene diisocyanate, toluene diisocyanate (TDI), isophorone diisocyanate (IPDI), hexamethylene diisocyanate (HDI) and dicyclohexylmethane-4,4-diisocyanate. MDI or TDI is preferable. Polyester polyol is polyester formed from dibasic acid and diol. The diol can have 2 to 10 carbon atoms, and the dibasic acid can be a straight or branched chain having 4 to 12 carbon atoms. Preferably, the polyester polyol is 1,4-butylene adipate. The chain extender is a diol having 2 to 12 carbon atoms; such as ethylene glycol, diethylene glycol, propylene glycol, dipropylene glycol, 1,4-butanediol, 1,6-hexanediol, 1,3-butylene glycol, 1,5-pentanediol, 1,4-cyclohexane dimethanol, neopentyl glycol, benzene diol, xylene glycol, or a combination thereof. The catalyst can be selected from triethylamine, dimethyl cyclohexylamine, stannous dioctoate, dibutyltin dioctoate, dibutyltin dilaurate, dibutyltin diacetate, and a combination thereof. Injection molding or extrusion processes can use various additives, such as pigments, fillers, antioxidants, reinforcing agents, lubricants, plasticizers, or the like.

The foaming agent in the foamable composition can be an organic foaming agent or an inorganic foaming agent. Examples of the organic foaming agents can be, for example, azo compounds (such as azodicarboxylic amide, azobisisobutyronitrile, diisopropyl azodicarboxylate), sulfonamide compounds (such as 4,4-oxybis benzene sulfonyl hydrazine, p-benzene sulfonyl hydrazine, 1,4-xylylene sulfonyl hydrazide), nitroso compounds (such as dinitroso terephthalic amide, N,N′-dinitroso pentamethylene tetramine), carbon dioxide (CO₂), hydrocarbons having 4 to 10 carbon atoms (such as n-pentane, isopentane and cyclopentane), or expandable microspheres (such as inflatable microcapsules, micro spherical foam powders). More preferably, the foaming agent is expandable microspheres.

In addition to the non-foamed thermoplastic polyurethane particles and the foaming agent, the foamable composition for preparing the foamed thermoplastic polyurethanes of the present invention can comprise the inorganic filler and the plasticizer as needed. The inorganic filler is, for example, talc powder, mica powder, sodium thiosulfate, or the like being used as the mold release agent. Preferably, the inorganic filler is talc powder. According to various embodiments, based on 100 parts by weight of the non-foamed thermoplastic polyurethane particles, there is preferably 0.1 to 5 parts by weight of talc powder. The plasticizer can be benzoic acid compounds (e.g., benzoates, such as methyl benzoate, ethyl benzoate, dipropylene glycol dibenzoate, etc., and derivatives thereof), esters (such aa triethyl citrate, trimethyl citrate, acetyl triethyl citrate, and derivatives thereof), ethers (such as adipic acid ether ester, glycol butyl ether ester, and derivatives thereof), polycaprolactones (such as polycaprolactone diol, and derivatives thereof), or polycarbonates (such as methyl polycarbonate, phenyl polycarbonate, and derivatives thereof). Benzoate or a derivative thereof is preferred. According to various embodiments, based on 100 parts by weight of the non-foamed thermoplastic polyurethane particles, there is preferably 1 to 20 parts by weight of the plasticizer.

In a preferred embodiment, the foamable composition for preparing the foamed thermoplastic polyurethane of the present invention has the following formulation: 100 parts by weight of the non-foamed thermoplastic polyurethane particles; 0.1 to 5 parts by weight of talc powder; 1 to 20 parts by weight of the plasticizer; and 5 to 25 parts by weight of the foaming agent, in which the non-foamed thermoplastic polyurethane particles have a viscosity from 10,000 poise to 40,000 poise measured at 170° C. according to JISK 7311 test method. If both talc powder and the plasticizer are needed, the formulation described above facilitates the formation of foamed thermoplastic polyurethanes having uniform pore size and particle size.

In addition, a variety of pigment powders can be added to the foamable composition. According to various embodiments, based on 100 parts by weight of the non-foamed thermoplastic polyurethane particles, there is preferably 0.1 to 5 parts by weight of pigment powders.

Method of Preparing Foamed Thermoplastic Polyurethanes

The method of preparing foamed thermoplastic polyurethanes through foaming and pelletizing will be illustrated by way of example below. First, the foamable composition having the formulation described above (comprising the non-foamed thermoplastic polyurethane particles and the foaming agent, or optionally added inorganic fillers, plasticizers, pigments, etc.) is poured into a single-screw pelletizer for foaming and pelletizing. The single-screw pelletizer has a die head temperature from 100° C. to 200° C., an extrusion speed from 50 kg/h to 70 kg/h, a die head pressure from 35 kgf/cm² to 65 kgf/cm², and an underwater pelletizing temperature from 10° C. to 20° C. Preferably, the die head temperature of the single-screw pelletizer is rom 135° C. to 175° C. The foaming and pelletizing method described above or other suitable methods can be used to prepare the foamed thermoplastic polyurethanes. It is noted that if the extrusion speed is too low, the particles would be excessively foamed (called screw-induced over foaming), leading to failure of microwave re-foaming.

The foamed thermoplastic polyurethane particles, each single particle having a plurality of colors, can be prepared in reference to the method described above. For example, a variety of foamable compositions, each composition containing a single color pigment, such as a first foamable composition containing a black pigment and a second foamable composition containing a red pigment, can be prepared first. Afterwards, the first foamable composition is added portion-wise into the single-screw pelletizer, during which a portion of the second foamable composition is added between any two portion-wise additions of the first foamable composition. In this way, the foamed thermoplastic polyurethanes having a variety of colors in each single particle can be formulated.

Foamed Thermoplastic Polyurethanes

The foamed thermoplastic polyurethanes of the present invention can be produced according to the foamable composition and the method thereof, but is not limited thereto. Preferably, the foamed thermoplastic polyurethanes of the present invention have a re-foaming property, i.e., the foamed thermoplastic polyurethanes of the present invention can be re-foamed by the treatment of microwave or other suitable methods to obtain a lower density. Specifically, in the preferred embodiments, the present invention provides the foamed thermoplastic polyurethanes having a density in the range of 0.2 g/cm³ to 0.8 g/cm³. The foamed thermoplastic polyurethanes are treated by microwave to re-foam and obtain a density in the range of 0.15 g/cm³ to 0.6 g/cm³, which is lower than the density before the microwave treatment. As described herein, the process of forming the foamed thermoplastic polyurethanes through the foaming and pelletizing of the foamable composition is referred to as the first foaming stage, and the process for the re-foaming of the foamed thermoplastic polyurethanes resulted from the first foaming stage is called the second foaming stage. In one preferred embodiment, the foamed thermoplastic polyurethanes formed at the first foaming stage have residual active foaming agent, but the present invention is not limited thereto. The re-foaming ability of the foamed thermoplastic polyurethanes might be enhanced by the residual active foaming agent, the level of which might be controlled by adjusting the formulation of the foamable composition or controlling the processes of the foaming and pelletizing. According to some embodiments of the present invention, the foamed thermoplastic polyurethanes formed at the first foaming stage preferably have a particle size from 3 mm to 7.5 mm. According to other embodiments of the present invention, the foamed thermoplastic polyurethanes formed at the first foaming stage preferably have a hardness of 40 Shore C scale to 80 Shore C scale. According to still other embodiments of the present invention, the foamed thermoplastic polyurethanes formed at the first foaming stage preferably have a density from 0.2 g/cm³ to 0.8 g/cm³. The foamed thermoplastic polyurethanes formed at the first foaming stage can have a variety of shapes, such as spherical, flaky, non-spherical, irregular shaped and the like.

Microwave Molded Article and the Method Thereof

The microwave molded article of the present invention is formed at the second foaming stage using microwave treatment. The foamed materials treated by microwave have pores that are more uniform and fine than that of the foamed thermoplastic polyurethanes not treated by microwave, and thus have the advantage of light weight. In addition, microwave treatment also makes the surfaces of the particles of the foamed thermoplastic polyurethanes bond with each other, and thus produces the microwave molded article. According to various embodiments, the microwave molded article prepared by the present invention can preferably have the following properties: a preferable hardness of 40 Shore C scale to 80 Shore C scale; and a preferable density of 0.15 g/cm³ to 0.6 g/cm³.

In accordance with various embodiments, the microwave molded article of the present invention can be prepared as follows: an appropriate amount of the foamed thermoplastic polyurethanes formed at the first foaming stage is put in a container, and then irradiated with microwave. The container can be a variety of molds, such as ceramic molds, plastic molds, glass molds, or composite molds made from metals and plastics, wherein the preferred one is composite molds made from metals and plastics. In the microwave foaming process, the power of the microwave is preferably from 500 watts (W) to 30,000 W, and more preferably from 1,000 W to 25,000 W at frequency for microwave 2,450 MHz, and the duration of microwave is from 3 seconds to 300 seconds, and more preferably from 5 seconds to 120 seconds. According to certain embodiments, no water is needed to add during the treatment of microwave. In some embodiments, water or alcohols can be added as the microwave medium during the treatment of microwave. In these embodiments, based on 100 parts by weight of the foamed thermoplastic polyurethanes, the medium is used in an amount of 1 part by weight to 10 parts by weight. The medium can be a polar medium, such as alcohols, including primary alcohols (e.g., methanol or ethanol) and secondary alcohols (e.g., ethylene glycol or propylene glycol), but is not limited thereto.

In summary, the thermoplastic polyurethane foam having all the advantages of light weight (high foaming ratio), stable quality, uniform distribution of pores, etc. can be produced by providing the foamable composition having suitable formulation and performing the first foaming stage and pelletizing process and the second stage microwave foaming process sequentially.

Various examples will be set forth below to illustrate the detailed description of the present invention in detail. The benefits and efficacy achieved by the present invention can be readily understood by those skilled in the art from the content of the specification, and various modifications and changes can be made by practicing and applying the contents of the present invention without departing from the spirit of the invention.

The first stage pelleting and foaming:

### EXAMPLES 1A TO 8A AND COMPARATIVE EXAMPLES 1A TO 5A

### EXAMPLE 1a

100 parts by weight of non-foamed thermoplastic polyurethane particles (trade name: Sunko-85A (M7851 MV7), having a hardness of 87 Shore A scale, available from Sunko Ink Co., Ltd.), 0.5 part by weight of talc powder, 1 part by weight of methyl benzoate (being the plasticizer), and 5 parts by weight of expandable microspheres (trade name: Expancel 930DU-120, available from Matsumoto, being the foaming agent) are mixed uniformly and poured into the single-screw pelletizer, which performs the first foaming stage and pelletizing process to obtain the preliminary foamed thermoplastic polyurethanes. The single-screw pelletizer is operated under the following conditions: a material extrusion speed of 70 kg/h, a die head pressure of 55 kgf/cm², a die head temperature of 155° C., and an underwater pelletizing temperature of 20° C. The preliminary foamed thermoplastic polyurethane has a density of 0.45 g/cm³ and is granular.

The preparation method of Examples 2a to 8a and Comparative Examples 1a to 5a may refer to that of Example 1a. The preparation conditions of Examples 1a to 8a are listed in Table 1. The preparation conditions of Comparative Examples 1a to 5a are listed in Table 3.

The second stage microwave foaming:

### EXAMPLES TO 1B TO8B AND COMPARATIVE EXAMPLES 1B TO 5B

### EXAMPLE 1b

50 parts by weight of the foamed thermoplastic polyurethane (named as la) obtained in Example la described above and 5 parts by weight of water are placed in a mold, which has a length of 25 cm, a width of 10 cm, and a height of 1.2 cm. Afterwards, the second stage microwave foaming process is performed using a microwave power of 500 W at frequency for microwave 2,450 MHz and a microwave duration of 180 seconds. After the mold is cooled down to 20° C., the preparation of the thermoplastic polyurethane microwave molded article 100 (shown in Figs. la and 1 b) is obtained, and the microwave molded article 100 has a density of 0.33 g/cm³.

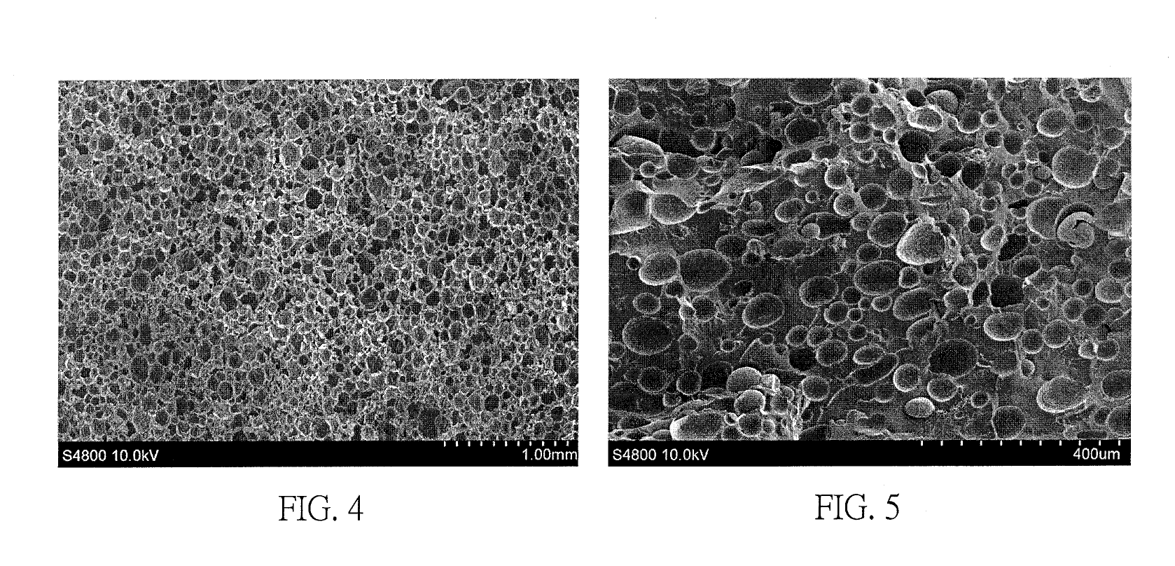

The preparation method of Examples 2b to 8b and Comparative Examples 1b to 5b may refer to that of Example 1b. The preparation conditions of Examples 1b to 8b are listed in Table 2. The preparation conditions of Comparative Examples 1b to 5b are listed in Table 4. FIG. 4 shows the scanning electron microscope (SEM) image of the microwave-foamed, molded article of Example 5b taken along the thickness direction from the outer surface to the inner layer.

### ANALYSIS AND DISCUSSION OF EXAMPLES AND COMPARATIVE EXAMPLES

### EXAMPLES 3A/3B AND COMPARATIVE EXAMPLES 1A/1B

### Excess Talc Powder

The preparation condition of Comparative Example 1a is the same as that of Example 3a, except that the amount of talc powder is 10 parts by weight in Comparative Example 1a. Since the amount of talc powder in Comparative Example 1a is excess, the particles in the single-screw pelletizer slipped due to the lower friction, resulting in failure of pelletizing. Comparative Example 1a is unable to obtain the required thermoplastic polyurethane foam particles (Comparative Example la is shown failed in Table 3), and thus the second stage microwave foaming process cannot proceed with (Comparative Example 1b is shown none in Table 4).

### EXAMPLES 3A/3B AND COMPARATIVE EXAMPLES 2A/2B

### Excess Plasticizer

The preparation condition of Comparative Example 2a is the same as that of Example 3a, except that the amount of the plasticizer is 25 parts by weight in Comparative Example 2a. Since the amount of the plasticizer in Comparative Example 2a is excess, the thermoplastic polyurethane foam particles in the single-screw pelletizer slipped due to the lower friction, resulting in failure of pelletizing. Comparative Example 2a is unable to obtain the required thermoplastic polyurethane foam particles (Comparative Example 2a is shown failed in Table 3), and thus the second stage microwave foaming process cannot proceed with (Comparative Example 2b is shown none in Table 4).

### EXAMPLES 7A/7B AND COMPARATIVE EXAMPLES 3A/3B

### Excessively High Viscosity

The preparation condition of Comparative Example 3a is the same as that of Example 7a, except that the viscosities of the non-foamed thermoplastic polyurethane particles are different. The viscosity of non-foamed particles in Comparative Example 3a is excessively high. Although the foamed thermoplastic polyurethane (with a density of 0.85 g/cm³) is successfully obtained in Comparative Example 3a, the particles fail to re-expand significantly after the treatment of microwave. In addition, after the treatment of microwave the particles collapse due to the lack of bonding between most of the particles and form a failed microwave molded article 200 without a full shape appearance (Comparative Example 3b is shown failed in Table 4). The failed microwave molded article 200 is shown in FIGS. 2a and 2b.

### EXAMPLES 8A/8B AND COMPARATIVE EXAMPLES 4a/4b

### Screw-Induced Over Foaming

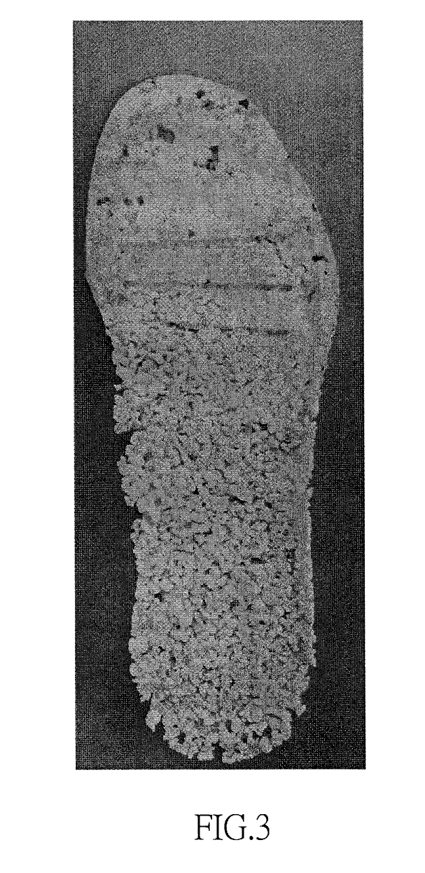

The preparation condition of Comparative Example 4a is the same as that of Example 8a, except that there is screw-induced over foaming in Comparative Example 4a (too slow extrusion speed). Although the foamed thermoplastic polyurethane (with a density of 0.17 g/cm³) is successfully obtained in Comparative Example 4a, the particles fail to re-expand significantly after the treatment of microwave. In addition, after the treatment of microwave the particles collapse due to the lack of bonding between most of the particles, and form a failed microwave molded article 300 without a full shape appearance (Comparative Example 4b is shown failed in Table 4 and also shown in FIG. 3.)

### EXAMLPES 8A/8B AND COMPARATIVE EXAMPLES 5A/5B

### Insufficient Amount of Foaming Agent)

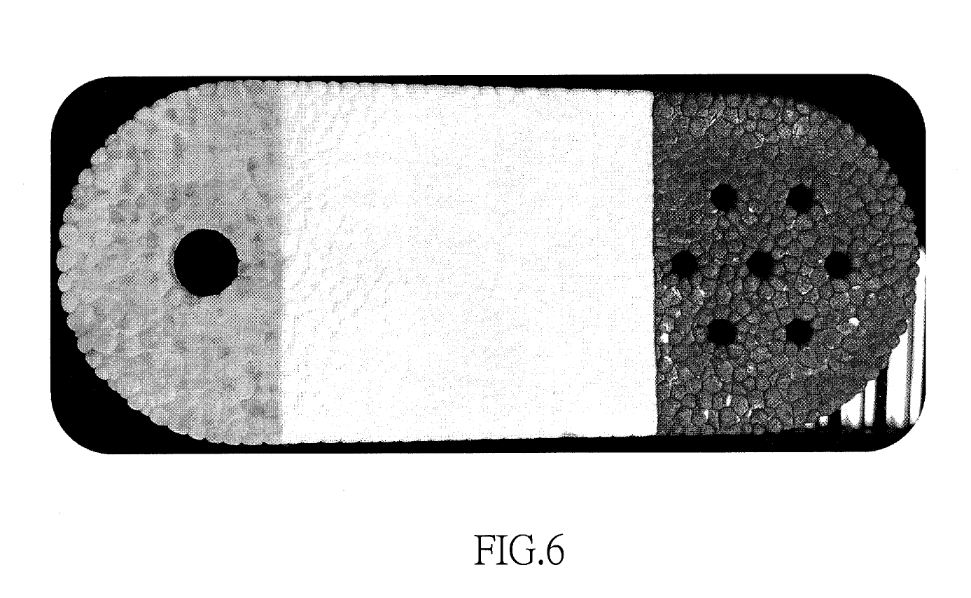

The preparation condition of Comparative Example 5a is the same as that of Example 8a, except that the amount of foaming agent is insufficient in Comparative Example 5a. Although the foamed thermoplastic polyurethane (having a density of 0.85 g/cm³) is successfully obtained in Comparative Example 5a, the particles fail to re-expand significantly after the treatment of microwave. In addition, after the treatment of microwave the particles collapse due to the lack of bonding between most of the particles, and the failed microwave molded article 300 without a full shape appearance is formed (Comparative Example 5b is shown failed in Table 4). FIG. 5 shows the scanning electron microscope (SEM) image of the failed microwave-foamed, molded article 300 taken along the thickness direction from the outer surface to the inner layer.

A single particle of the foamed thermoplastic polyurethane having a plurality of colors

### EXAMPLE 9

### Bicolor Foamed Thermoplastic Polyurethane

100 parts by weight of thermoplastic polyurethane particles (trade name: Sunko-85A (M7851 MV7), having a hardness of 87 Shore A scale, available from Sunko Ink Co., Ltd.), 0.5 part by weight of talc powder, 1 part by weight of methyl benzoate (being the plasticizer), 0.5 part by weight of black pigment powder, and 5 parts by weight of expandable microspheres (trade name: Expancel 930DU-120, available from Matsumoto, being the foaming agent) are mixed uniformly and named as Raw material A. Besides, 100 parts by weight of Sunko-85A (M7851 MV7), 0.5 part by weight of talc powder, 1 part by weight of methyl benzoate, 0.5 part by weight of white pigment powder, and 5 parts by weight of expandable microspheres are mixed uniformly and named as Raw material B. Raw material A is divided into several small portions. So does Raw material B. Each small portion A and B are poured by turns into the single-screw pelletizer, which performs the first foaming stage and pelletizing process to obtain the foamed thermoplastic polyurethanes particles, each is chequered (alternately colored) with black and white. The single-screw pelletizer operated under the following conditions: a material extrusion speed of 70 kg/h, a die head pressure of 55 kgf/cm², a die head temperature of 155° C., and an underwater pelletizing temperature of 20° C. The foamed thermoplastic polyurethane has a density of 0.44 g/cm³.

Microwave molded article having a surface with a designed pattern

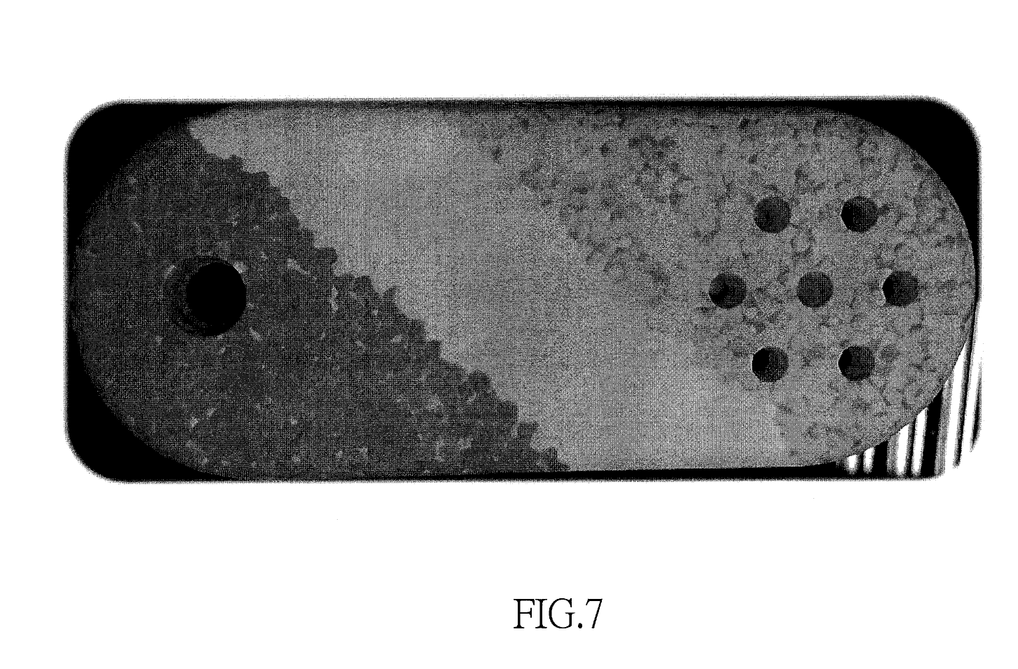

In reference to the above described methods, a microwave molded article with a designed pattern as shown in Fig.6 is made by purposely arranging colorful particles of the foamed thermoplastic polyurethane within a mold, in light of the pre-sketched designed pattern. In accordance with another embodiment of the present invention, a photo as Fig.7 shows a shoe insole which is also a microwave molded article having a designed pattern with different colors.

TABLE 1

| The first | | | | | | | | | |
|---|---|---|---|---|---|---|---|---|---|
| foaming | | | | | | | | | |
| stage and | | | | | | | | | |
| pelletizing | | Ex. 1a | Ex. 2a | Ex. 3a | Ex. 4a | Ex. 5a | Ex. 6a | Ex. 7a | Ex. 8a |
| Non- | Wt. % | 100 | 100 | 100 | 100 | 100 | 100 | 100 | 100 |
| foamed | Trade | SUNKO-85A | SUNKO-95A | SUNKO-70A | SUNKO-70A | SUNKO-40A | SUNKO-85A | SUNKO-85A | SUNKO-65A |
| TPU | name | M7851MV7 | HA1095MV | T1705LVM | T1705LVM | T945PLM2 | M7851MV7 | M7851MV7 | M165VM |
| | Shore | 87A | 95A | 70A | 70A | 40A | 87A | 87A | 67A |
| | hardness | | | | | | | | |
| | Viscosity | 25,000 | 28,000 | 17,500 | 17,500 | 10,000 | 25,000 | 25,000 | 15,000 |
| | (poise) | | | | | | | | |
| | Density | 1.15 | 1.17 | 1.14 | 1.14 | 1.12 | 1.15 | 1.15 | 1.13 |
| | (g/cm³) | | | | | | | | |
| | Particle | 3.0 | 3.0 | 3.5 | 3.5 | 4.0 | 3.0 | 3.0 | 3.5 |
| | diameter | | | | | | | | |
| | (mm) | | | | | | | | |
| Talc | Wt. % | 0.5 | 0.5 | 5.0 | 5.0 | 0.1 | 0.5 | 0.5 | 0.5 |
| powder | | | | | | | | | |
| Methyl | Wt. % | 1 | 20 | 5.0 | 5.0 | 5 | 1 | 1 | 1 |
| benzoate | | | | | | | | | |
| Foaming | Type | Expandable | Calcium | Expandable | Expandable | Expandable | Expandable | Expandable | Expandable |
| agent | | microspheres | carbonate | microspheres | microspheres | microspheres | microspheres | microspheres | microspheres |
| | | 930DU-120 | | 930MB-120 | 930MB-120 | 930DU-120 | 930DU-120 | 930DU-120 | 930DU-120 |
| | Wt. % | 5 | 10 | 25 | 25 | 20 | 25 | 5 | 7 |
| Screw | | no over | no over | no over | no over | no over | no over | no over | no over |
| condition | | foaming | foaming | foaming | foaming | foaming | foaming | foaming | foaming |
| Extrusion | kg/h | 70 | 70 | 50 | 50 | 50 | 70 | 70 | 50 |
| speed | | | | | | | | | |
| Die head | kgf/cm² | 55 | 65 | 35 | 35 | 45 | 55 | 55 | 40 |
| pressure | | | | | | | | | |
| Die head | ° C. | 155 | 175 | 135 | 135 | 140 | 155 | 155 | 155 |
| temp. | | | | | | | | | |
| Underwater | ° C. | 20 | 20 | 10 | 10 | 20 | 20 | 20 | 20 |
| pelletizing | | | | | | | | | |
| temp. | | | | | | | | | |
| Preliminary | Name | 1a | 2a | 3a | 4a | 5a | 6a | 7a | 8a |
| foamed | Shore | 73C | 75C | 68C | 68C | 43C | 70C | 73C | 65C |
| TPU | hardness | | | | | | | | |
| | Density | 0.45 | 0.65 | 0.40 | 0.40 | 0.23 | 0.37 | 0.45 | 0.35 |
| | (g/cm³) | | | | | | | | |
| | Particle | 5.5 | 3.0 | 4.0 | 4.0 | 7.0 | 6.0 | 5.5 | 6.0 |
| | diameter | | | | | | | | |
| | (mm) | | | | | | | | |

TABLE 2

| The second stage | | | | | | | | | |
|---|---|---|---|---|---|---|---|---|---|
| microwave foaming | | Ex. 1b | Ex. 2b | Ex. 3b | Ex. 4b | Ex. 5b | Ex. 6b | Ex. 7b | Ex. 8b |
| Preliminary | Name | 1a | 2a | 3a | 4a | 5a | 6a | 7a | 8a |
| foamed | Wt. % | 50 | 50 | 50 | 50 | 50 | 50 | 50 | 50 |
| TPU | | | | | | | | | |
| Medium | Type | Water | Water | Water | Alcohol* | Water | Water | None | None |
| | Wt. % | 5 | 5 | 5 | 5 | 5 | 5 | 0 | 0 |
| Microwave | W | 500 | 800 | 300 | 300 | 1000 | 500 | 5000 | 5000 |
| power | | | | | | | | | |
| Microwave | sec | 180 | 180 | 30 | 30 | 20 | 180 | 60 | 50 |
| duration | | | | | | | | | |
| Microwave | Shore | 65C | 70C | 60C | 60C | 40C | 60C | 65C | 58C |
| molded | hardness | | | | | | | | |
| article | Density | 0.33 | 0.48 | 0.25 | 0.26 | 0.17 | 0.20 | 0.34 | 0.30 |
| | (g/cm³) | | | | | | | | |

*Methanol/Ethylene glycol = 9/1

TABLE 3

| The first foaming stage | | | | | | |
|---|---|---|---|---|---|---|
| and pelletizing | | Comp. Ex.1a | Comp. Ex. 2a | Comp. Ex. 3a | Comp. Ex. 4a | Comp. Ex. 5a |
| Non-foamed | Wt.% | 100 | 100 | 100 | 100 | 100 |
| TPU | Trade | SUNKO-70A | SUNKO-70A | SUNKO-85-1A | SUNKO-65A | SUNKO-65A |
| | name | T1705LVM | T1705LVM | H785M | M165VM | M165VM |
| | Shore | 70A | 70A | 87A | 67A | 67A |
| | hardness | | | | | |
| | Viscosity | 17,500 | 17,500 | 90,000 | 15,000 | 15,000 |
| | (poise) | | | | | |
| | Density | 1.14 | 1.14 | 1.15 | 1.13 | 1.13 |
| | (g/cm³) | | | | | |
| | Particle | 3.5 | 3.5 | 3.0 | 3.5 | 3.0 |
| | diameter | | | | | |
| | (mm) | | | | | |
| Talc Powder | Wt. % | 10.0 | 5.0 | 0.5 | 0.5 | 0.5 |
| Methyl | Wt. % | 5.0 | 25.0 | 1.0 | 1.0 | 1 |
| benzoate | | | | | | |
| Foaming | Type | Expandable | Expandable | Expandable | Expandable | Expandable |
| agent | | microspheres | microspheres | microspheres | microspheres | microspheres |
| | | 930MB-120 | 930MB-120 | 930DU-120 | 930DU-120 | 930DU-120 |
| | Wt. % | 25 | 25 | 5 | 7 | 2 |
| Screw | | no over | no over | no over | over foaming | no over |
| condition | | foaming | foaming | foaming | | foaming |
| Extrusion | kg/h | Failed | Failed | 70 | 15 | 60 |
| speed | | | | | | |
| Die head | kgf/cm² | | | 105 | 20 | 35 |
| pressure | | | | | | |
| Die head | ° C. | | | 155 | 175 | 145 |
| temp. | | | | | | |
| Underwater | ° C. | | | 20 | 30 | 20 |
| pelletizing | | | | | | |
| temp. | | | | | | |
| Preliminary | Name | | | 3a′ | 4a′ | 5a′ |
| foamed | Shore | | | 90C | 55C | 75C |
| TPU | hardness | | | | | |
| | Density | | | 0.85 | 0.17 | 0.85 |
| | (g/cm³) | | | | | |

TABLE 4

| | | Comp. Ex. | Comp. Ex. | Comp. Ex. | Comp. Ex. | Comp. Ex. |
|---|---|---|---|---|---|---|
| The second stage microwave foaming | | 1b | 2b | 3b | 4b | 5b |
| Preliminary foamed | Name | None | None | 3a′ | 4a′ | 5a′ |
| TPU | Wt. % | | | 100 | 100 | 100 |
| Medium | Type | | | None | None | None |
| | Wt. % | | | 0 | 0 | 0 |
| Microwave power | W | | | 5000 | 5000 | 5000 |
| Microwave duration | sec | | | 60 | 50 | 50 |
| Microwave molded | Shore hardness | | | Failed | Failed | Failed |
| article | Viscosity (poise) | | | | | |
| | Density (g/cm³) | | | | | |
| | Particle diameter | | | | | |
| | (mm) | | | | | |

What is claimed is:

1. A foamable composition for preparing foamed thermoplastic polyurethane, comprising non-foamed thermoplastic polyurethane particles and a foaming agent, wherein the non-foamed thermoplastic polyurethane particles have a viscosity between 10,000 poise and 40,000 poise measured at 170° C. according to JISK 7311 test method.

2. The foamable composition of claim 1, wherein the viscosity of the non-foamed thermoplastic polyurethane particles is between 15,000 poise and 35,000 poise.

3. The foamable composition of claim 1, wherein the non-foamed thermoplastic polyurethane particles have a particle size between 2.5 mm and 4.5 mm.

4. The foamable composition of claim 1, wherein the non-foamed thermoplastic polyurethane particles have a hardness of 40 Shore A scale to 64 Shore D scale.

5. The foamable composition of claim 1, wherein the non-foamed thermoplastic polyurethane particles have a density between 1.0 g/cm³ and 1.25 g/cm³.

6. The foamable composition of claim 1, comprising 100 parts by weight of the non-foamed thermoplastic polyurethane particles and 5 to 25 parts by weight of the foaming agent.

7. The foamable composition of claim 1, comprising 100 parts by weight of the non-foamed thermoplastic polyurethane particles and 5 to 20 parts by weight of the foaming agent.

8. The foamable composition of claim 1, wherein the foaming agent is composed of expandable microspheres, carbon dioxide (CO₂) or hydrocarbons having 4 to 10 carbon atoms.

9. The foamable composition of claim 1, further comprising 0.1 to 5 parts by weight of talc powder.

10. The foamable composition of claim 1, further comprising 1 to 20 parts by weight of a plasticizer, wherein the plasticizer is benzoate or a derivative thereof.

11. The foamable composition of claim 1, further comprising 0.1 to 5 parts by weight of pigment powders, based on 100 parts by weight of the non-foamed thermoplastic polyurethane particles.

12. A foamed thermoplastic polyurethane, prepared through the foaming and pelletizing of the foamable composition of claim 1.

13. The foamed thermoplastic polyurethane of claim 12, wherein the foamed thermoplastic polyurethane contains residual foaming agent.

14. The foamed thermoplastic polyurethane of claim 12, wherein the foamed thermoplastic polyurethane has a particle size between 3 mm and 7.5 mm.

15. The foamed thermoplastic polyurethane of claim 12, wherein the foamed thermoplastic polyurethane has a hardness of 40 Shore C scale to 80 Shore C scale.

16. The foamed thermoplastic polyurethane of claim 12, wherein the foamed thermoplastic polyurethane has a density between 0.2 g/cm³ and 0.8 g/cm³.

17. The foamed thermoplastic polyurethane of claim 12, wherein a single particle of the foamed thermoplastic polyurethane has a plurality of colors.

18. A microwave molded article, prepared from the foamed thermoplastic polyurethane of claims 12 being treated by microwave.

19. The microwave molded article of claim 18, wherein the microwave molded article has a density between 0.15 g/cm³ and 0.6 g/cm³.

20. The microwave molded article of claim 18, wherein the microwave molded article has a hardness of 40 Shore C scale to 80 Shore C scale.

21. The microwave molded article of claim 18, wherein a surface of the microwave molded article has a designed pattern.

22. A method of manufacturing the microwave molded article of claim 18, wherein a power of microwave is between 500 W and 30,000 W.

23. The method of claim 22, wherein the duration of microwave is between 3 seconds and 300 seconds.

24. The method of claim 22, wherein no water is added during the treatment of microwave.

25. The method of claim 22, wherein 1 to 10 parts by weight of water or alcohol is added during the treatment of microwave, based on 100 parts by weight of the foamed thermoplastic polyurethane.

26. The method of claim 22, further comprising using a container to contain the foamed thermoplastic polyurethane for carrying out the treatment of microwave, wherein the container is a composite of metal and a plastic.
